(19) United States
(12) Patent Application Publication
(10) Pub. No.: US 2009/0287528 A1
(43) Pub. Date: Nov. 19, 2009

(54) DYNAMIC SELECTION OF WORK FLOWS BASED ON ENVIRONMENTAL CONDITIONS TO FACILITATE DATA ENTRY

(76) Inventors: Robert Strickland, Bellevue, WA (US); Erez Yarkoni, Gig Harbor, WA (US)

Correspondence Address: PERKINS COIE LLP;PATENT-SEA, P.O. BOX 1247, SEATTLE, WA, 98111-1247, US

(21) Appl. No.: 12/414,640

(22) Filed: Mar. 30, 2009

Related U.S. Application Data
(60) Provisional application No. 61/054,370, filed on May 19, 2008.

(51) Int. Cl. G06Q 10/00; G06F 3/048

(52) U.S. Cl. 705/9; 705/11; 715/747

(57) ABSTRACT

A system and method for selecting a work flow to direct a user to an appropriate form and facilitate the entry of data. The system identifies one or more environmental conditions that are associated with the data that is to be entered. Environmental conditions may include the size of the display on which the form will be displayed, the user that will be utilizing the form, the location, date and/or time that the form will be displayed, and other conditions. Based on the identified environmental conditions, the system selects a work flow that will efficiently direct the user to an appropriate form or series of forms for data entry. The system may select a work flow from a plurality of template work flows. The system may monitor paths taken by users within a work flow and seek to optimize the work flow based on the monitored paths.

### CROSS-REFERENCE TO RELATED APPLICATION

This application claims the benefit of U.S. Provisional Application No. 61/054,370 entitled “DYNAMIC SELECTION OF WORK FLOWS BASED ON ENVIRONMENTAL CONDITIONS TO FACILITATE DATA ENTRY,” filed May 19, 2008.

### BACKGROUND

In any industry offering products or services to consumers, there is often a need to receive information from a consumer. In some circumstances, the information may be directly entered by a consumer in a form containing one or more fields. For example, a consumer may purchase a product and visit the product manufacturer's web site and enter information about the purchase (e.g., consumer name, address, phone number, email, item purchased, place of purchase, price of purchase etc.) in order to register the product and activate the warranty. In other circumstances, the information may be entered by a sales person at a point of sale. For example, when purchasing a mobile phone, a consumer may be required to provide personal and financial information to the sales agent in order to enable the mobile phone service. In still other circumstances, a customer service agent may receive information from a consumer over the phone and enter the information into a computer database. It will be appreciated that there are many other circumstance under which information may need to be received from a consumer in order for a company to provide some benefit to the consumer. Managing the receipt of information from consumers in a cost-efficient manner is a goal of all companies, since customer service can be a significant expense to a business. Particularly in subscription-based companies, such as cable companies, satellite companies, telecommunications companies, mobile telecommunications companies, etc., which have large numbers of customers, it would be advantageous to lower the cost of receiving information from consumers in order to reduce expenses and offer better value to consumers.

While interfaces to receive information from consumers or other parties are quite common, they are typically not very convenient. Because of the large number of individuals that are expected to use any interface, interfaces are often designed to have the broadest possible applicability. For example, automated teller machines (ATMs) are a prime example of a system with an interface that offers broad functionality at the expense of convenience. Although a consumer may visit the same ATM once a week to make a cash withdrawal of $100, the ATM will always request that the consumer enter the language they want to use when visiting the machine and the amount the consumer would like to withdraw. Even though the language of the consumer presumably won't change, nor is it likely that the consumer will want to withdraw more than $100, the ATM continues to present those options to the consumer in order to ensure that the consumer has access to the broadest range of functionality. As another example of an inefficient data entry interface, after the holidays a salesperson at a store may have to traverse a large menu structure in order to arrive at a form that allows a consumer to return a product that was received as a gift. The salesperson may be required to traverse the large menu structure each time that a return occurs, even though a large number of the transactions that occur after the holidays may be returns rather than purchases. In both cases, the appropriate data is ultimately received from the consumer. Unfortunately, however, there is a tremendous amount of inefficiency associated with entering the data as measured by the time and effort required to traverse unnecessary menu structures. It would therefore be beneficial to develop an improved way of querying users in order to receive desired information.

### BRIEF DESCRIPTION OF THE DRAWINGS

FIG. 1A is a block diagram of an environment in which a system for dynamically selecting work flows to facilitate data entry operates.

FIG. 1B is a block diagram of system components that enable the creation, selection, and modification of work flows.

FIG. 2 is a flow chart of a process for selecting a work flow for use under particular environmental conditions.

FIG. 3 is a representative interface such as might be presented to a salesperson selling products or services at a telecommunications store.

FIGS. 4A-4C are representative work flows that are utilized by the system depending on the detected environmental conditions.

FIG. 5 is a representative interface that depicts a work flow used as a graphical construct in addition to use as a logical construct.

FIG. 6 is a flow chart of a process for tracking statistics on the use of a work flow, and using the statistics to modify the work flow.

### DETAILED DESCRIPTION

A system and method for selecting an optimal work flow (i.e., a series of questions, menus, cues, or other options interspersed with a data-entry form or forms) to present to a user an appropriate form or series of forms and facilitate the entry of data is disclosed herein. The system identifies one or more environmental conditions that are associated with the data that is to be received. Environmental conditions analyzed by the system may include, but are not limited to, the size of the display on which a form will be displayed, the actual or estimated expertise of the user that will be utilizing the form, the geography or region in which the form will be displayed, the date and/or time that the form will be displayed, the volume of work flows being processed by the system, and any other conditions that may impact the entry of data. Based on the identified environmental conditions, the system selects one more work flows that will efficiently present the user with an appropriate form or forms for entry of data by the user.

Selecting a work flow from a plurality of template work flows allows the system to optimize the work flow for a particular situation. For example, in environments with skilled users and large device screens, the work flow may contain a large number of options to allow the user to quickly locate a form that allows data entry by the user. In environments with unskilled users or small device screens, the work flow may be simplified and the user allowed to sequentially enter data in a series of forms with limited fields. Regardless of the work flow that is selected, the form or forms generated by the system gathers the same or a similar scope of information from the user. The different work flows merely attempt to optimize the manner in which a user enters data under different environmental conditions, thereby reducing the time to fulfill requests or inquiries by customers.

In some embodiments, the particular work flows utilized by the user as well as the paths taken by the user within each work flow are monitored by the system as the user enters information. The system may store the particular work flows and paths taken by the user in an account associated with that user so that the work flows may be further modified to meet the needs of the particular user. The system may also aggregate information about selected work flows and paths taken by a user with similar information from other users in order to modify the work flows to better suit the needs of groups of individuals.

It will be appreciated that the selection of optimal work flows provides several advantages to system users. Information is received in a more efficient manner from consumers, thereby improving the consumer experience while at the same time potentially minimizing the errors in the received information. Costs are lowered to a business that uses the system, thereby allowing the business to pass the savings along to its customers in the form of lower prices. And various new input devices may be used by a business that are be optimized for the work flows. For example, while complex interfaces typically rely on the use of a keyboard and a mouse for the input of data, optimized work flows may be implemented with simpler user input devices such as a joystick.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

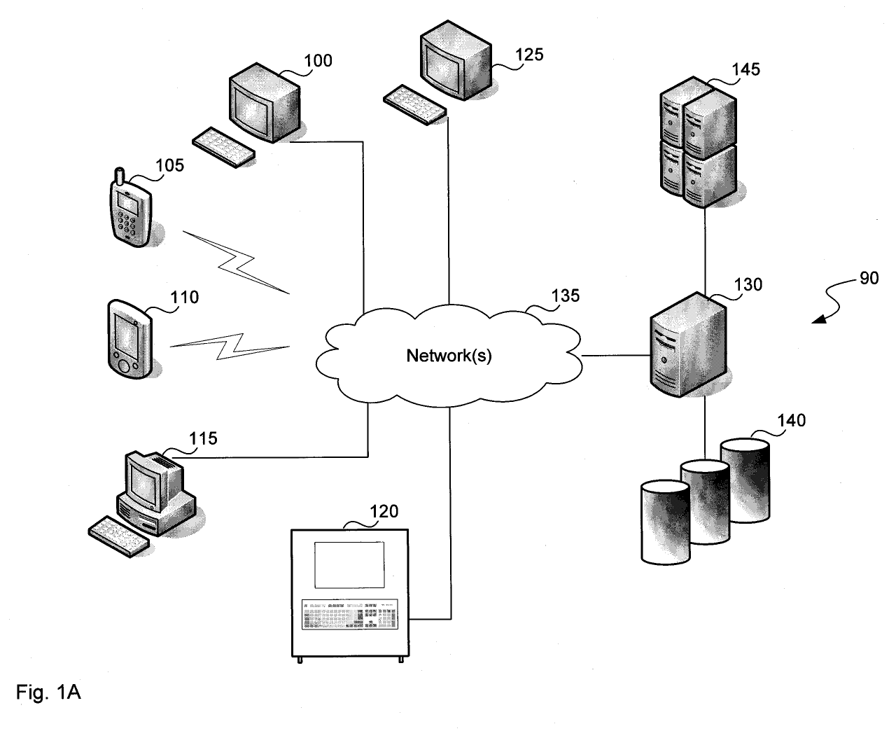

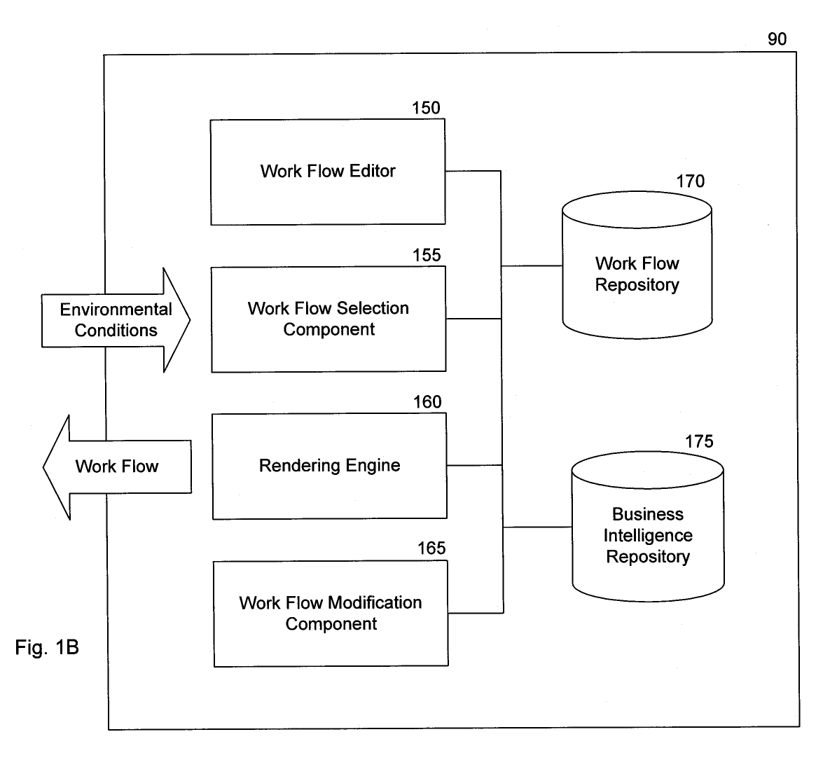

FIG. 1A is a block diagram of an environment in which a system 90 for selecting work flows to facilitate data entry operates. A work flow is a series of questions, menus, cues, or other options (individually or collectively, “options”) that are interspersed with a data-entry form or forms and which guide a user through the form or forms to enable the user to enter data via a device. Devices that interact with or incorporate the system may include, but are not limited to, a point of sale terminal 100, a smart phone 105, a PDA or other portable computing device 110, a computer 115, a kiosk 120, or a data terminal 125. The device may have standard input technology (e.g., keyboard and mouse) or input technology that is optimized for a particular work flow (e.g., a joystick or other game-like controller). In order to facilitate the user's entry of such data, the system selects work flows that present the user with an appropriate form or forms for entering data. The work flows are optimized for the particular environmental conditions under which the user is entering data. The environmental conditions evaluated by the system may include, but are not limited to, the size of the display on which the form will be displayed, the actual or estimated expertise of the user that will be utilizing the form, the geography or region in which the form will be displayed, the date and/or time that the form will be displayed, the volume of work flows being processed by the system (i.e., the current load on the system), and other conditions. The selection of a particular work flow facilitates the entry of data by the user under the detected environmental conditions. The system presents the selected work flow to the user on the device, and the user is allowed to enter the data via the resulting forms in a quick and efficient manner. As the user enters data, the system monitors the use of the work flow and in particular notes when the user leaves or terminates the work flow. By examining multiple instances of a single user's interaction with a work flow, or the interactions of a group of users with the work flow, the system may subsequently modify the options contained in the work flow in order to improve the performance of the work flow.

The system 90 to select work flows may be incorporated in an application that is operational on a remote server 130 or servers that are accessed via public or private networks 135. The server 130 may be coupled to one or more services 145 that utilize data received via a work flow. For example, services 145 may be customer service, billing, accounting, CRM, or other back-end systems that rely on the data received from users. The server 130 is also coupled to a data storage area 140, such as a data warehouse. The data storage area may contain a plurality of work flow templates that are selected by the system based on the identified environmental conditions. The data storage area may also contain a record of one or more user interactions with each work flow that may be used to modify the work flow. Various queries may be applied against data stored in the data storage area in order to identify appropriate work flows or to mine user interactions with work flows. The data storage area stores applications and data in a computer readable medium, such as magnetic- and optically-readable computer discs, tape drives, computer memory chips (e.g., EEPROM and other flash memory chips), or other storage media. In some embodiments, the system may be partially or fully incorporated into an application that is operational on the device that receives user data.

FIG. 1B is a block diagram of components in the system 90 that enable the creation, selection, and dynamic modification of work flows. The system includes a work flow editor 150 that allows a user to initially construct a work flow. Work flows may be created from scratch by a system operator, or may be created by selecting and modifying a prior work flow that is similar to a desired work flow. The work flow editor 150 may also contain a library of common workflow elements that may be stitched together to create a work flow. For example, the work flow editor may contain a standard work flow element that pertains to receiving credit card information from a consumer and another standard work flow element that pertains to receiving a consumer's address. A system operator may select standard work flow elements and combine them with new material in order to construct a new work flow. Once a work flow has been constructed, it is stored in a work flow repository 170 for subsequent access by the system.

As will be described in additional detail herein, when the system 90 receives a request for a data entry interface, the system 90 responds by selecting an optimal work flow for the environmental conditions under which the request is being made. A work flow selection component 155 receives the request and determines one or more environmental conditions under which the request is being made. The environmental conditions may be transmitted to the system by the requesting device, or may be detected by the work flow selection component. Based on the determined environmental conditions, the work flow selection component 155 selects a desired work flow from the work flow repository 170.

Once the desired work flow has been selected by the work flow selection component 155, a rendering engine 160 interprets the selected work flow, generates a user interface consistent with the work flow, and transmits the user interface to the user's device. The rendering engine is configured to translate the stored representation of the work flow into a user interface format that is suitable for the device that accesses the work flow. For example, the rendering engine may adjust the user interface for a small display in one device and for a larger display in another device. In some embodiments, the rendering engine may convert the work flow into spoken instructions for a device that has no display but has a speaker. As will be described in additional detail herein, as the rendering engine 160 renders the selected work flow and presents a corresponding user interface to the user, the rendering engine tracks a user's interaction with the workflow, such as the selections make by the user and the information entered by the user. Some or all of the details of the user's interactions with the work flow are stored by the rendering engine 160 in a business intelligence repository 175. The business intelligence repository therefore contains a record of actual work flow usage that may be mined by the system in order to improve the work flows.

The system also contains a work flow modification component 165. On a periodic or intermittent basis, the work flow modification component analyzes the performance of one or more work flows by examining the data stored in the business intelligence repository 175. The stored data may be used to assess the efficacy of each work flow, such as by examining the number of times that each work flow is used by the system, the accuracy of information that is received via a work flow, the completion rate of a work flow (i.e., the percent of users that complete a work flow after it is started), the time it takes to complete a work flow, and any other measures of the performance of a work flow, either by itself or in comparison with similar work flows. Based on the analyzed performance of a workflow, the work flow modification component 165 may indicate that a work flow should be used more or less frequently, may modify the work flow to improve the work flow, or may delete the work flow in its entirety in favor of another work flow. In some circumstances, the work flow modification component 165 may allow two different versions of a work flow to be used by the system, and the performance of each work flow compared against each other. By allowing different versions of a work flow to compete against each other, the work flow modification component can assess which work flow performs better under different environmental conditions. After testing for a certain period of time, the work flow modification component may select one of the work flows over the other based on the performance data. Additional information about the process used to optimize work flows is described herein.

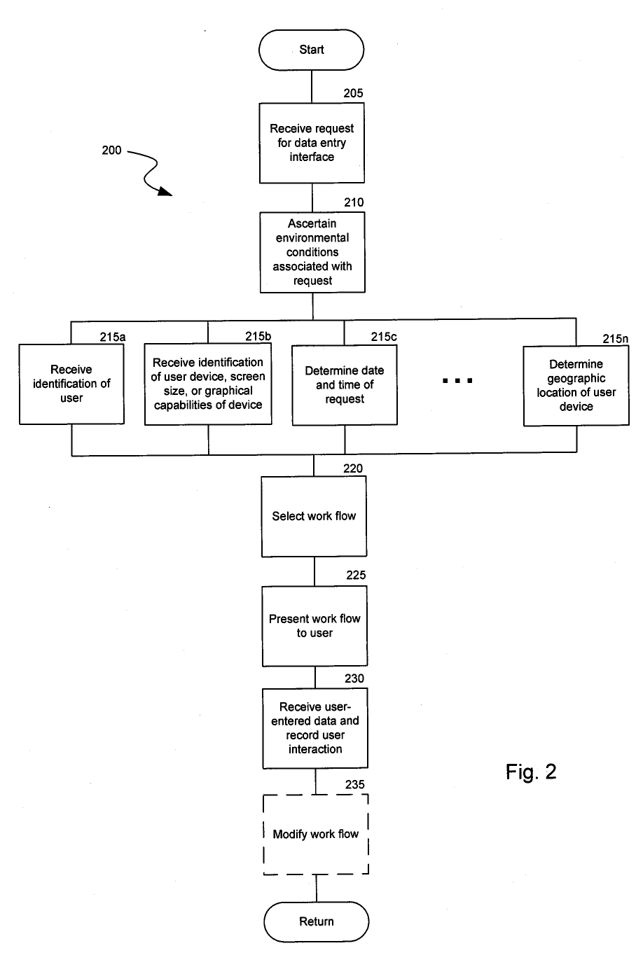

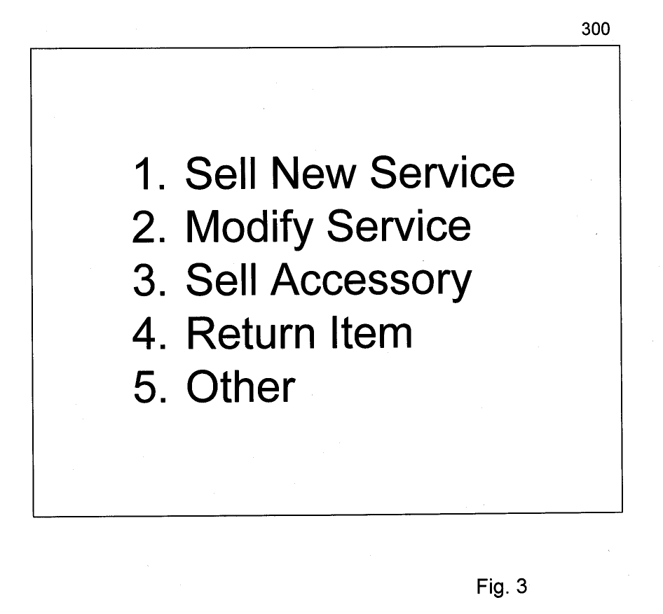

FIG. 2 is a flow chart of a process 200 implemented by the system to select a work flow for use under particular environmental conditions. At a block 205, the system receives a request for a data entry interface from an application being used by a user. Such a request may be generated in a variety of contexts. For example, a user might be a salesperson at a mobile phone store that needs to enter a customer's personal and financial information in order to register that customer for service. As another example, a user might be a consumer who purchased a new electronic device and then went to a website offered by the manufacturer of that device in order to register the device for warranty protection. As another example, a user might be a customer service agent that needs to enter new shipment information for an order that was placed by a customer. The request may be generated by an application program (such as a web browser) that interfaces with the system, or the request may be generated by an application program that incorporates the functionality of the system. The request contains sufficient information for the system to identify the type of data that needs to be entered by the user in order to be responsive to the request. For example, FIG. 3 is a representative initial interface 300 that might be presented to a salesperson at a mobile phone or device store. Five menu choices are presented to the salesperson, including “Sell New Service,” “Modify Service,” “Sell Accessory,” “Return Item,” and “Other.” When the salesperson makes a selection of one of the menu choices, the system is thereby provided with sufficient information to understand the general nature of the request (e.g., a particular product or service) and the type of information that will need to be provided by the salesperson in order to fulfill the request.

At a block 210, the system identifies one or more environmental conditions that are associated with the user request. The environmental conditions may be identified in a variety of ways, including: (i) the environmental conditions may be encoded and received by the system in the initial request from the user; (ii) the system may query the device for additional information after receiving the initial request of the user; (iii) the system may receive sufficient information to allow the system to consult one or more databases containing information about the user or device; or (iv) the system may receive the data via any other comparable channel. The environmental conditions may be identified only once for each user or device, such as when the user or device first accesses the system, or the environmental conditions may be identified on a periodic or continuous basis, such as every time the user or device accesses the system. The various environmental conditions that may be identified by the system are enumerated in blocks 215a, 215b . . . 215n:
At a block 215a, the system may receive information identifying the user. The identification information may be determined by the user logging on to an application that utilizes the system and providing a unique user ID and password. Alternatively, the user may be identified by detecting a cookie that is stored by a browser being used by the user. As will be described herein, the identity of the user may be used by the system to select the work flow and modify the work flow that is presented to the user.
At a block 215b, the system may receive information that identifies the type of the device, the size of the screen on the device, and/or the graphical capabilities of the device being used by the user. To facilitate the use of device information, the system may store information characterizing the capabilities of various devices in the work flow repository 170. If not explicitly provided, received device identification information may therefore be correlated with the information contained in the data storage area in order to identify the screen size and capabilities of the device. As will be described herein, the screen size of a device and the graphical capabilities of a device may determine the work flow that is presented to the user.
At a block 215c, the system may determine the date and/or the time of the request. As will be described herein, the date and/or time may be used to determine any modifications to the work flow that are presented to the user.
At a block 215n, the system may determine the geographic location of the user device. As will be described herein, the geographic location may be used to determine any modifications to the work flow that are presented to the user.

At a block 220, the system uses the identified environmental conditions in order to select work flows that are optimized for the application, the user, and the device being used by the user to enter data. The system may take a variety of environmental conditions into account when selecting work flows for presentation to the user:
The identity of the user may be used by the system to assess the sophistication of the work flow that is presented to the user. For example, the system may track the number of times that the user has used a particular work flow. The more experience the user has with a particular work flow, the less guidance or cues the system may need to display to the user to facilitate the entry of data using the work flow. As another example, the system may track the length of time that a user has been an employee of a company that utilizes the system. Employees with a longer period of tenure with a company may be presented with a streamlined work flow, as their time with the company may imply a greater familiarity with the processes and systems of the company.
The size of the display available on the device and the capabilities of the device may impact the selected work flow. For example, a larger display may allow the presentation of a greater number of data entry fields to a user, whereas a smaller display may limit the number of data entry fields that may be presented to a user. Similarly, devices having high resolution color displays may offer a greater opportunity to provide visual cues in a work flow using graphics and icons, as compared with devices having low-resolution monochrome displays. The system may therefore utilize the known characteristics of a device in order to select an appropriate work flow for presentation on the device.

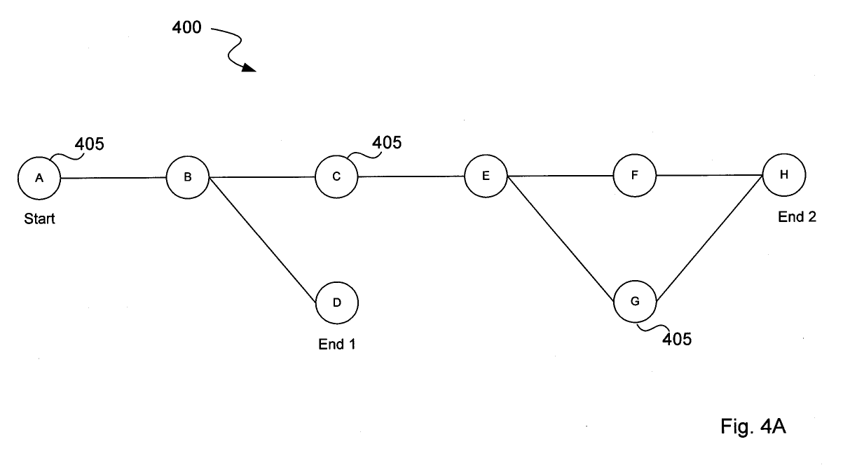

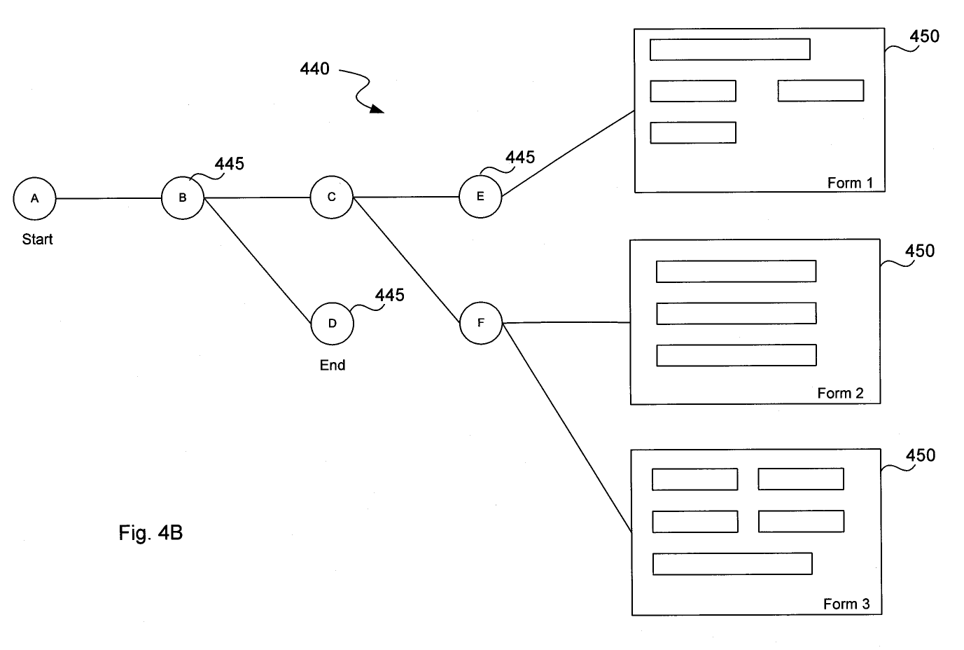

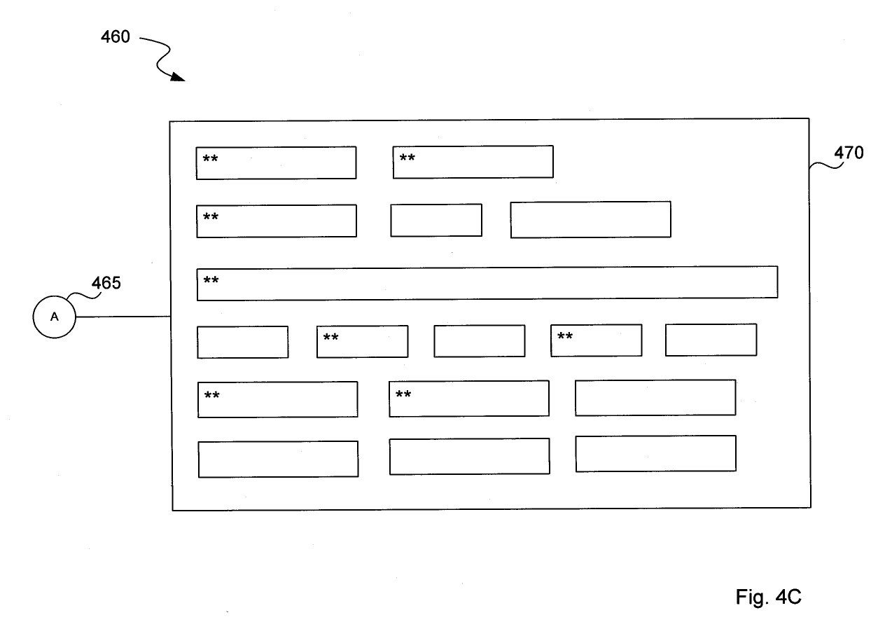

FIGS. 4A-4C depict examples of the types of work flows that may be selected by the system. FIG. 4A depicts a work flow 400 that is beneficial for inexperienced users, for applications having small amounts of data that need to entered, or for devices having a small screen. The work flow 400 is depicted as a tree of interconnected nodes 405. Each node reflects either a field for data entry (e.g., nodes A, C, D, F, G, H) that is presented to a user, or a question, menu, cue, or other option that a user responds to in order to progress to two or more connecting nodes (e.g., nodes B, E). Work flow 400 is characterized in that there may be limited branching in the structure and the user may be presented with a small number of fields at each node for the entry of data. A user starts at the left-most node in the work flow and progresses to the right in the structure along a path that depends on the responses by the user at each option node. Two end nodes (nodes D, H) exist, depending on the particular selections made by the user.

FIG. 4B depicts a work flow 440 that is beneficial for more experienced users, for applications having a moderate amount of data that needs to be entered, or for devices having a medium screen. The work flow 440 is depicted as a tree of interconnected nodes 445. Each node reflects either a field for data entry (e.g., nodes A, D, E) that is presented to a user, or a question, menu, cue, or other option that a user responds to in order to progress to two or more connecting nodes or forms (e.g., nodes B, C, F). Once a user has traversed a limited number of nodes in the work flow, the user is presented with a form 450 that pertains to the path that was traversed by the user. Each form contains a moderate number of fields for data entry, and different forms may have a different number or type of fields. The work flow 440 is characterized in that the number of branching levels in the structure may be limited, and the user may be presented with one or more forms containing a moderate number of fields for data entry following a limited traversal of the work flow.

FIG. 4C depicts a work flow 460 that is beneficial for expert users, for applications having a significant amount of data that needs to be entered, for devices having a large screen, or as a default work flow. The work flow 460 is depicted as a single node 465 having an option that, once selected, takes the user to an associated form 470. The form contains a large number of fields for data entry, only some of which may need to be completed by the user. In the representative form 470, the required fields are characterized by the characters “**”. The work flow 460 is characterized in that the little or no branching is required before arriving at a form containing a large number of fields for data entry.

It will be appreciated that the work flows depicted in FIGS. 4A-4C are merely representative examples of the types of structures that may be stored and utilized by the system. The system may maintain a large number of work flows for different applications that vary based on such features as: (i) the number of nodes; (ii) the depth of each work flow; (iii) the number of branches at each option node; (iv) the number and type of fields contained in forms that are reached while traversing the work flow; and (v) other factors.

The system may select one or more work flows to use in a particular application. For example, the representative interface depicted in FIG. 3 has five menu options that a user may select. The system may assign a different work flow for each of the five menu options, if different work flows would lend themselves to the type of data that needs to be entered for each menu option. For example the work flow depicted in FIG. 4C may be particularly applicable to the “Other” menu option since the depicted work flow provides the greatest flexibility of data entry. It will be appreciated that the system may assign the same work flow to each menu option, or may use any other assignment permutation. The system attempts to select the best work flow for each menu option under the environmental conditions in which the menu option is selected.

Once the work flow has been selected by the system, at a block 225 the work flow is presented by the system to the requesting user. The user steps through the work flow, responding to the various options (e.g., answering questions, selecting appropriate menu items) and entering data. At a block 230, the system receives the user-entered data. The system may also record the series of interactions that the user had with the work flow as the user entered data. The type of interaction information that may be captured and stored by the system includes, but is not limited to:
User_ID—An identifier associated with a user that is utilizing the work flow. The User_ID may uniquely identify the user or may identify the user as a member of a group having particular qualities (e.g., new employees, customer service representatives, etc.). Storing a user identifier allows interaction information to be subsequently segmented for analysis.
Work Flow ID—An identifier that indicates which work flow was presented to the user by the rendering engine.
Customer ID—An identifier associated with the customer that the user is currently assisting.
Timestamp—A date and/or time stamp that records the time when the work flow was initiated by the user. A second timestamp may be stored that indicates when the user finished or terminated the work flow.
Other Environmental Conditions—Any information that provides context about how the work flow was accessed by the user, such as the geographic location of the user or the type of device used by the user.
Work Flow Use Data—Data reflecting the options selected by the user as the user traversed the work flow and entered data into work flow forms. Some of the important metrics that may be measured by the system include how often a user fails to complete a particular work flow, at what point they terminate a work flow, and what steps they take after terminating the work flow.
   As will be discussed in greater detail herein, the record of individual or aggregate interactions may also be used to modify the work flow.

On a frequent or infrequent basis, at a block 235 the system may modify one or more of the work flows based on an analysis of the detected environmental information and the interaction of one or more users with the work flow. Such modification may involve changing the sequence of the options within the work flows, adding options, removing options, changing the graphical treatment of options by highlighting or emphasizing certain options, deleting a work flow in favor of another work flow, promoting one work flow over another work flow, etc. For example:
The date and/or time that a request was made may impact a work flow and the resulting displayed form, since the type of information that a user is expected to enter may fluctuate on a seasonal basis. For example, a salesperson may see an increase in product returns in January as people return gifts that were received over the holiday. As a result, the system would promote options related to returns higher in a work flow, while demoting options that were not related to returns. The type of information that a user may be expecting to enter may also fluctuate throughout the day. For example, a customer service agent for a cable company may receive more calls scheduling appointments in the morning, and more calls about billing issues in the evening. As a result, the system might promote options in a work flow pertaining to scheduling in the morning, while promoting options in the work flow related to billing in the evening. The system may therefore utilize the date and time information to reorder options contained in a work flow to emphasize the type of information that is expected to be received during the associated period.
The geographic location of the request may impact a work flow and the resulting displayed form. The geographic location may be as granular as a particular store, or as broad as a particular region or country. For example, a mobile phone store that is located near an office park may sell more phones having speakerphone capabilities, whereas a mobile phone store that is located near a college may sell more phones having text messaging capability. In the latter case, the work flows that are selected by the system for use when making a new phone sale may promote options pertaining to text messaging plans, in order to mirror the type of sales that occur more frequently at that location.

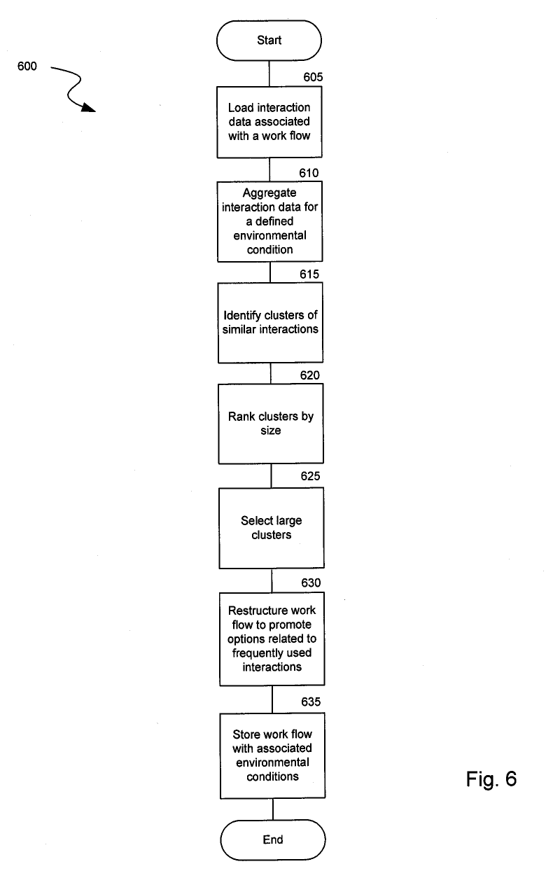

It will be appreciated that the modification of a work flow may be performed by the system on a frequent or infrequent basis. The modified work flows are stored by the system in the work flow repository 170, with appropriate metadata associated with the work flow so that the work flow selection component 155 can identify which work flow to use under different environmental conditions. For example, one work flow associated with a particular type of data entry may have associated metadata indicating use between the hours of 8 am-noon, and a second work flow may have associated metadata indicating use for all other hours. By storing the work flows with metadata, the system may quickly access the work flow when it is needed by a particular application. In addition, by storing the work flows the system may allow a system operator to quickly construct new work flows for new processes that are implemented by an application, or modify existing work flows to account for new products or services. To construct a new work flow, the system operator may locate a similar stored work flow and use the flow as a template for the construction of the new work flow. To modify an existing flow, such as to add a new product that is sold by a service provider, the system operator may edit the work flow to add or remove nodes to the flow. Additional modifications to a work flow may be made as a result of the actual use of the work flow, as will be discussed in additional detail with respect to FIG. 6.

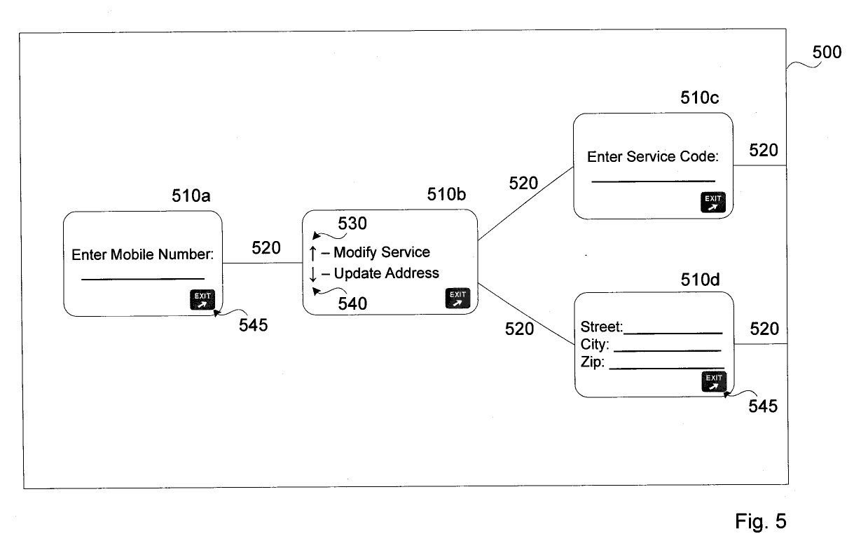

In addition to representing the logical sequence of questions, menus, cues, forms, or other options that are presented to a user, a work flow may also reflect the visual manner in which questions, menus, cues, forms, or other options are presented to the user. That is, rather than each node in a work flow representing a different screen that is displayed to a user, each node and the links between the nodes may be presented graphically to a user so that the user may traverse along the nodes as data is entered. FIG. 5 is a representative interface 500 that depicts a work flow being used as a graphical construct. Each node 510a, 510b, 510c and 510d is displayed on the interface, and linked by lines 520 that indicate the paths between nodes. Starting at node 510a, a user may enter information requested by the system, which in the displayed example is the user's mobile telephone number. After performing the required action at node 510a, the user may traverse to the next connected node. That is, after entering the required information at node 510a, the user may automatically or manually traverse to node 510b. At node 510b, the user is provided two options, to modify services or to update an address. After selecting an option in node 520b, the user is directed to node 510c or node 510d depending on the selected option. After entering the required information at nodes 510c or 510d, the user traverses to the next connected nodes which are not yet displayed on the screen. It will be appreciated that the graphical depiction of the work flow will scroll left-to-right or top-to-bottom as a user performs required actions and traverses the work flow. The scrolling brings new nodes onto the screen for the user, while removing nodes that the user has already acted upon. Because of the simple action of traversing along a linked tree of nodes, the depicted interface is particularly suited for use with input devices such as joysticks or other game-like controllers. For example, each option shown in node 520b has an associated “up” arrow 530 or “down” arrow 540 to indicate the direction to move a joystick in order to select that option. In a very intuitive manner, moving the joystick upwards causes the user to traverse to node 510c in the upper branch of the work flow, and moving the joystick downwards causes the user to traverse to node 510d in the lower branch of the work flow. A user is therefore able to quickly and easily enter information that is requested by the system.

As shown in FIG. 5, when a screen is presented to a user at each node, the screen contains an icon 545 on the lower portion of each screen that the user may use to exit the work flow. When a user selects an icon, the user is taken to a form containing a large number of fields for data entry, such as the form depicted in FIG. 4C. The form that the user may be redirected to is typically a default form that has not been optimized for the particular information that needs to be received from the user. By offering the user a mechanism to opt out of an optimized work flow and return to a default work flow, the system achieves at least two benefits. First, it allows users to quickly switch to a different user interface if they are becoming frustrated with the initial user interface. Allowing the user to switch may therefore result in a greater likelihood that information will be entered by the user, since the second user interface that is presented may be more acceptable to the user. Second, by offering the user a mechanism to exit a work flow on each screen of the work flow, the system can readily track the exact point at which users leave a particular work flow. The system can utilize such information to assess the efficacy of the corresponding work flow and determine whether improvements can be made to the work flow. Although depicted on the embodiment of FIG. 5, it will be appreciated that an icon may be displayed on data entry screens associated with FIGS. 4A-4B and any other screens generated by the system.

It will be appreciated that one of the advantages of the system is that each form in the system may be tailored to receive only those aspects of the user's information that are necessary for the particular application. For example, while a user's social security number may be an important number of have when setting up a customer's account with a wireless service provider, the user's social security number is not necessary when the user is merely purchasing a hands-free handset. In contrast to prior interfaces which may not have distinguished the type of information that needed to be received by an application, the present system allow the system operator to tailor forms reached via work flows to only encompass those pieces of information that are strictly necessary for the application. Such tailoring protects sensitive user information and may help insure compliance with data protection laws.

FIG. 6 is a flow chart of a process 600 for tracking statistics on the use of a work flow and using the statistics to modify the work flow. On a periodic basis, the system may automatically modify one or more stored work flows so that the work flows more accurately reflect the predominant uses of the work flows by an individual user or a group of users. At a block 605, the system loads interaction data associated with a work flow. As previously noted, the system may store interaction data each time a user traverses a work flow and enters data. The stored interaction data may be retrieved by the system on a per-user basis, if the work flow is to be optimized for a particular individual, on a group basis, if the work flow is to be optimized for a group of individuals, or on a global basis, if the work flow is to be optimized for the entire population of individuals that use the system. At a block 610, the system aggregates the interaction data based on a selected environmental condition. For example, as was previously described, there may be variability in how work flows are used depending on the time, location, user, etc. The system may therefore partition the interaction data based on an environmental condition at block 610 in order to identify work flow use trends associated with that condition.

At a block 615, the system analyzes the interaction data in order to identify clusters of data associated with similar interactions. That is, the system may examine each interaction of a user with a work flow and group together like interactions. At a block 625, the system selects one or more large clusters of interactions. Large clusters of interactions represent commonly-used interaction paths within a work flow, so the system may seek to optimize the work flow by focusing on those paths.

At a block 630, the system restructures the work flow to promote those options that are associated with the most commonly-used interaction paths. For example, an interaction path that branches in a work flow at a third level of nodes within the work flow node structure may instead be promoted so that a user can branch in the work flow at the first level of nodes within the node structure. By promoting the node at which the branch occurs from the third level of nodes to the first level of nodes, the user is thereby saved having to traverse two levels of nodes. Such an optimization allows the user to enter the data associated with the interaction path in a much more timely fashion. As another example, an interaction path that is rarely used may be demoted within the node structure of a work flow. Although the interaction path associated with the demoted nodes may still be traversed by a user, demoting the node will simplify the traversal time for users taking more common interactions paths. Those skilled in the art will appreciate that other optimizations may, of course, be performed by the system to work flows by analyzing the most commonly-used interaction paths.

At a block 635, the system stores the modified work flow. The modified work flow may be stored with metadata indicating the associated environmental conditions for which it has been optimized. For example, if the work flow was optimized for a single user, the work flow would be stored with metadata that associates that user with the work flow. When the system went to present a work flow to the user, the system would select and use the optimized flow. As another example, if the work flow was optimized for a particular timeframe, the work flow would be stored in a manner that associates the work flow with the timeframe. If the system went to present a work flow to the user, and the time that the work flow was to be presented fell within the associated timeframe, the system would select and utilize the optimized flow.

The process depicted in FIG. 6 may be repeated for any number of work flows. Work flows may be periodically modified (e.g., monthly, annually, etc.) or sporadically modified (e.g., when a certain threshold of data is collected, when new products or services are added to an application that utilizes the system, etc.). After a certain amount of use data about a particular work flow has been collected and the work flow optimized, the work flow may be locked and no further changes may be made to the flow. The performance of different work flows that are designed to solicit similar information from a user may also be compared against one another. The system may select the better-performing work flow, while deleting the poorly-performing work flow.

With reference again to FIG. 3, a representative use of the system will now be briefly described. FIG. 3 depicts an interface 300 such as might be presented to a salesperson at a mobile phone or device store. Five menu options are presented to the salesperson, and for each option the salesperson may need to enter one or more pieces of consumer data in order to complete a transaction. The owner of the mobile phone store may initially use the system to select a work flow for each of the menu options. Each work flow may be created from scratch, or an existing stored work flow that is similar to the desired flow may be selected and modified to create the desired flow. The menu options may have similar work flows, or each menu option may have a different work flow. For example, the work flow depicted in FIG. 4C may be suitable for option 5 (“Other”) because of the number of pieces of information that may need to be entered by the salesperson. In contrast, the work flow depicted in FIG. 4A may be suitable for option 3 (“Sell Accessory”) because of the limited amount of information that needs to be collected by the salesperson in order to make such a sale. As a salesperson uses the work flows that were selected by the store owner, the system records the interaction path of each use. Using data derived from the interaction paths, the system may optimize the interface in a number of ways. The type of work flow associated with each menu item may be changed by the system. For example, the work flow may be simplified or made more complex depending on the use patterns. The system may also reorder the menu items so that more frequently used work flows are promoted towards the top of the menu, and less used menu items are demoted towards the bottom of the menu. For example, if the number of returns suddenly increased at a store, option 4 may be promoted to the second item in the menu list. If a salesperson were to switch from a terminal operated at the counter in the store to a handheld portable device that allows the salesperson to roam the store and complete orders, the system would detect the shift to a different device and would change the work flows and associated forms/screens accordingly. For example, while the “Sell Accessory” work flow may remain unchanged, the “Other” work flow may change because the flow depicted in FIG. 4C is not suitable for a device with a small screen. Finally, the system may also detect the individual salesperson that is accessing the menu, and tailor the work flows to the salesperson. While a wide variety of optimizations are described for the particular use shown in FIG. 3, those skilled in the art that one, some, or all of the optimizations described herein may be used to improve the entry of data from the user.

From the foregoing, it will be appreciated that specific embodiments of the invention have been described herein for purposes of illustration, but that various modifications may be made without deviating from the spirit and scope of the invention. For example, the system can be implemented in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices, and portions of the invention may reside on a server computer while other portions reside on a client computer. Aspects of the system described herein may be stored or distributed on computer-readable media, including magnetic- and optically-readable and removable computer discs, stored as firmware in chips (e.g., EEPROM chips), or other storage media. Those skilled in the art will appreciate that the actual implementation of the data storage area may take a variety of forms, and the phrase “data storage area” is used herein in the generic sense to refer to any area that allows data to be stored in a structured and accessible fashion using such applications or constructs as databases, tables, linked lists, arrays, and so on. Those skilled in the art will further appreciate that the blocks shown in FIGS. 2 and 6 may be altered in a variety of ways. For example, the order of the blocks may be rearranged, blocks may be performed in parallel, blocks may be omitted, or other blocks may be included. Accordingly, the invention is not limited except as by the appended claims.

I/We claim:

1. A method performed by a computing system having a processor and memory for selecting and presenting a work flow that elicits data from a user of a device, the computer-implemented method comprising:
receiving a request to enter data on a device by a user;
identifying one or more environmental conditions associated with the request;
selecting a work flow from a plurality of work flows that differ in complexity, the selected work flow based on the request and at least one of the identified one or more environment conditions;
presenting the selected work flow to the user; and
receiving data from the user as a result of the user traversing the presented work flow.

2. The computer-implemented method of claim 1, wherein an environmental condition is an identification of the user.

3. The computer-implemented method of claim 1, wherein an environmental condition is an identification of the device.

4. The computer-implemented method of claim 1, wherein an environmental condition is a size of a display on the device.

5. The computer-implemented method of claim 1, wherein an environmental condition is a graphical capability of the device.

6. The computer-implemented method of claim 1, wherein an environmental condition is a time of the request.

7. The computer-implemented method of claim 1, wherein an environmental condition is a geographic location of the device.

8. The computer-implemented method of claim 1, further comprising:
tracking a path of the user as the user traverses the presented work flow; and
storing data characterizing the path of the user.

9. The computer-implemented method of claim 8, further comprising:
analyzing the stored data characterizing the path of the user; and
modifying the selected work flow based at least in part on the analysis of the stored data.

10. The computer-implemented method of claim 1, wherein the one or more environmental conditions are identified every time a request to enter data is received.

11. A system for selecting and presenting a work flow that elicits data from a user of a device, the system comprising:
a work flow repository that stores a plurality of work flows that differ in complexity;
a work flow selection component coupled to the work flow repository, the work flow selection component configured to receive a request to enter data on a device by a user, identify one or more environmental conditions associated with the request, and select a work flow from the stored plurality of work flows, the selected work flow based on the request and on at least one of the identified one or more environment conditions; and
a rendering engine coupled to the work flow selection component and the work flow repository, the rendering engine configured to access the selected work flow from the stored plurality of work flows, present the selected work flow to the user; and receive data from the user as a result of the user traversing the presented work flow.

12. The system of claim 11, wherein an environmental condition is an identification of the user.

13. The system of claim 11, wherein an environmental condition is an identification of the device.

14. The system of claim 11, wherein an environmental condition is a size of a display on the device.

15. The system of claim 11, wherein an environmental condition is a graphical capability of the device.

16. The system of claim 11, wherein an environmental condition is a time of the request.

17. The system of claim 11, wherein an environmental condition is a geographic location of the device.

18. The system of claim 11, further comprising a business intelligence repository, wherein the rendering engine is coupled to the business intelligence repository and is further configured to track a path of the user as the user traverses the presented work flow and store data characterizing the path of the user in the business intelligence repository.

19. The system of claim 18, further comprising a work flow modification component that is coupled to the business intelligence repository and the work flow repository, the work flow modification component being configured to analyze the stored data characterizing the path of the user and modify the selected work flow based at least in part on the analysis of the stored data.

20. The system of claim 11, wherein the one or more environmental conditions are identified every time a request to enter data is received.

21. A computer-readable storage medium storing instructions that, when executed by a computing system, cause the computing system to execute a method of selecting and presenting a work flow that elicits data from a user of a device, the method comprising:
receiving a request to enter data on a device by a user;
identifying one or more environmental conditions associated with the request;
selecting a work flow from a plurality of work flows that differ in complexity, the selected work flow based on the request and at least one of the identified one or more environment conditions;
presenting the selected work flow to the user; and
receiving data from the user as a result of the user traversing the presented work flow.

22. The computer-readable storage medium of claim 21, wherein the one or more environmental conditions are selected from the group consisting of: an identification of the user, an identification of the device, a size of a display on the device, a graphical capability of the device, a time of the request, and a geographic location of the device.

25. The computer-readable storage medium of claim 21, wherein the one or more environmental conditions are identified every time a request to enter data is received.

24. A method performed by a computing system having a processor and memory for modifying a work flow to improve the efficacy of the work flow in eliciting information from users, the computer-implemented method comprising:
presenting a preferred work flow for eliciting information to a plurality of users, the preferred work flow comprising a sequence of data-entry forms that are to be completed by a user, at least some of the sequence of data-entry forms containing an exit control that allows a user to switch from the preferred work flow to a default work flow;
tracking the use of the presented preferred work flow by the plurality of users as the plurality of users respond to the preferred work flow and enter information into the sequence of data-entry forms, the tracked use including detecting when a user operates an exit control to switch from the preferred work flow to the default work flow;
storing data characterizing the use of the preferred work flow by the plurality of users;
analyzing the stored data characterizing the use of the preferred work flow; and
modifying the preferred work flow based at least in part on the analysis of the stored data.

25. The computer-implemented method of claim 24, wherein modifying the preferred work flow comprises promoting frequently-used sequences of data-entry forms completed by the plurality of users in the preferred work flow.

26. The computer-implemented method of claim 24, wherein modifying the preferred work flow comprises demoting infrequently-used sequences of data-entry forms completed by the plurality of users in the preferred work flow.

27. The computer-implemented method of claim 24, wherein analyzing the stored data characterizing the use of the preferred work flow comprises segmenting the stored data in accordance with at least one environmental condition that existed when each of the plurality of users responded to the preferred work flow and entered information into the sequence of data-entry forms.

28. The computer-implemented method of claim 27, wherein the environmental condition is a characteristic of a device used to enter information.

29. The computer-implemented method of claim 27, wherein the environmental condition is time.

30. The computer-implemented method of claim 27, wherein the environmental condition is a geographic location of a device used to enter information.

31. A system for modifying a work flow to improve the efficacy of the work flow in eliciting information from users, the system comprising:
a storage area for storing data;
a rendering engine coupled to the storage area and configured to present a preferred work flow for eliciting information to a plurality of users, the preferred work flow comprising a sequence of data-entry forms that are to be completed by a user, at least some of the sequence of data-entry forms containing an exit control that allows a user to switch from the preferred work flow to a default work flow, the rendering engine further configured to track and store data in the storage area characterizing the use of the presented preferred work flow by the plurality of users as the plurality of users respond to the preferred work flow and enter information into the sequence of data-entry forms, the stored data including data reflecting when a user operates an exit control to switch from the preferred work flow to the default work flow; and
a work flow modification component coupled to the storage area and configured to analyze the stored data characterizing the use of the preferred work flow and modify the preferred work flow based at least in part on the analysis of the stored data.

32. The system of claim 31, wherein the work flow modification component modifies the preferred work flow by promoting frequently-used sequences of data-entry forms completed by the plurality of users in the preferred work flow.

33. The system of claim 31, wherein the work flow modification component modifies the preferred work flow by demoting infrequently-used sequences of data-entry forms completed by the plurality of users in the preferred work flow.

34. The system of claim 31, wherein the work flow modification component analyzes the stored data characterizing the use of the preferred work flow by segmenting the stored data in accordance with at least one environmental condition that existed when each of the plurality of users responded to the preferred work flow and entered information into the sequence of data-entry forms.

35. The system of claim 34, wherein the environmental condition is a characteristic of a device used to enter information.

36. The system of claim 34, wherein the environmental condition is time.

37. The system of claim 34, wherein the environmental condition is a geographic location of a device used to enter information.

38. A computer-readable storage medium storing instructions that, when executed by a computing system, cause the computing system to execute a method of modifying a work flow to improve the efficacy of the work flow in eliciting information from users, the method comprising:
presenting a preferred work flow for eliciting information to a plurality of users, the preferred work flow comprising a sequence of data-entry forms that are to be completed by a user, at least some of the sequence of data-entry forms containing an exit control that allows a user to switch from the preferred work flow to a default work flow;
tracking the use of the presented preferred work flow by the plurality of users as the plurality of users respond to the preferred work flow and enter information into the sequence of data-entry forms, the tracked use including detecting when a user operates an exit control to switch from the preferred work flow to the default work flow;
storing data characterizing the use of the preferred work flow by the plurality of users;
analyzing the stored data characterizing the use of the preferred work flow; and
modifying the preferred work flow based at least in part on the analysis of the stored data.

39. The computer-readable storage medium of claim 38, wherein modifying the preferred work flow comprises promoting frequently-used sequences of data-entry forms completed by the plurality of users in the preferred work flow.

40. The computer-readable storage medium of claim 38, wherein modifying the preferred work flow comprises demoting infrequently-used sequences of data-entry forms completed by the plurality of users in the preferred work flow.

41. The computer-readable storage medium of claim 38, wherein analyzing the stored data characterizing the use of the preferred work flow comprises segmenting the stored data in accordance with at least one environmental condition that existed when each of the plurality of users responded to the preferred work flow and entered information into the sequence of data-entry forms.

42. The computer-readable storage medium of claim 38, wherein the at least one environmental condition is selected from the group consisting of: a characteristic of a device used to enter information, time, and a geographic location of a device used to enter information.
